(19) United States
(12) Patent Application Publication
(10) Pub. No.: US 2026/0213095 A1
(43) Pub. Date: Jul. 23, 2026

(54) CONTROL SWITCH HAVING PROTECTION FUNCTION

(71) Applicant: NINGBO ICLIPPER ELECTRIC APPLIANCE CO.,LTD, Ningbo (CN)

(72) Inventor: Haoze WU, Ningbo (CN)

(21) Appl. No.: 19/235,668

(22) Filed: Jun. 12, 2025

(30) Foreign Application Priority Data
Jan. 21, 2025 (CN) 202520140735.8

(51) Int. Cl. H01H 15/24; H01H 9/02; H01H 9/04; H01H 15/04; H01H 15/10

(52) U.S. Cl. CPC H01H 15/24; H01H 9/0214; H01H 9/04; H01H 15/04; H01H 15/10

(57) ABSTRACT

A control switch having a protection function comprising a switch assembly; the switch assembly comprises a shifting rod and a fixing member for mounting the shifting rod, and the fixing member is provided with a notch for mounting the shifting rod; a first end of the shifting rod extends into the fixing member and is hinged to the fixing member, and a second end of the shifting rod extends out from the fixing member; a soft rubber pad is arranged on the shifting rod in a sleeving mode, and the soft rubber pad covers the notch; when propelling the shifting rod, it propels the soft rubber pad to deform, so that the soft rubber pad always covers a gap between the notch and the shifting rod; thus, the hair is prevented from entering the switch assembly from the gap such that the operating reliability of the switch assembly is improved.

### TECHNICAL FIELD

This invention generally relates to the technical field of control switches, and more particularly, to a control switch having a protection function.

### BACKGROUND

An electric hair cutter is an electric tool for cutting hair, which is widely used in a person's daily life. Normally, the electric hair cutter includes a housing, a cutter head having a blade, a driving mechanism for propelling the cutter head to operate, and a switch for controlling the startup and stopping of the driving mechanism. In the prior art, the switch of the electric hair cutter may be divided into a key type or a shifting rod type, wherein the shifting-rod-type switch comprises a shifting rod and a switch piece having

conductivity, and the switch piece is propelled by the shifting rod to move to enable the switch piece to be turned on or off, thereby achieving the startup and stopping of the electric hair cutter.

Chinese patent CN216831006U discloses an electric hair cutter comprising a housing, a switch assembly mounted on the housing and a movement body, wherein the switch assembly comprises a shifting rod and a fixing member. In actual use, the aforesaid solution has the following shortcomings: as shown in FIG. 1, because a gap is formed between the shifting rod 11′ of the switch assembly 1′ and the fixing member 12′, when the electric hair cutter operates, the cut hair may easily enter the interior of the switch assembly 1′ through the gap between the shifting rod 11′ and the fixing member 12′. The hair entering the interior of the switch assembly 1′ severely affects the conducting performance of the switch piece, thereby affecting the normal startup and stopping of the electric hair cutter.

Therefore, it is urgent for those skilled in the art to provide a novel control switch having a protection function.

### SUMMARY

The purpose of the present invention is to provide a control switch having a protection function capable of solving the prior problem that the hair cut by the electric hair cutter enters the interior of the switch assembly through the gap formed between the shifting rod and the fixing member of the switch assembly to affect the conducting performance of the switch piece so that the normal startup and stopping of the electric hair cutter is further affected.

To achieve the above purpose, the present invention adopts the following technical solution: a control switch having a protection function comprises a switch assembly; the switch assembly further comprises a shifting rod and a fixing member for mounting the shifting rod, and the fixing member is provided with a notch for mounting the shifting rod; a first end of the shifting rod extends into the fixing member and is hinged to the fixing member, and a second end of the shifting rod extends out from the fixing member; a soft rubber pad is arranged on an outer peripheral side of the shifting rod in a sleeving mode, and the soft rubber pad covers the notch; when the shifting rod is propelled, the soft rubber pad is propelled by the shifting rod to deform, so that the soft rubber pad always covers a gap formed between the notch and the shifting rod.

In another preferred embodiment, the periphery of the soft rubber pad is fixedly connected to the fixing member.

In another preferred embodiment, the fixing member is provided with a clamping portion for fixing two ends of the soft rubber pad, and the two ends of the soft rubber pad are respectively provided with a clamping port for interacting with the clamping portion.

In another preferred embodiment, the fixing member is provided with a T-shaped clamping block for fixing a side edge of the soft rubber pad, and the side edge of the soft rubber pad is provided with a strip-shaped notch engaged with the T-shaped clamping block.

In another preferred embodiment, the soft rubber pad is provided with a through hole for interacting with the shifting rod, and an inner side wall of the through hole is tightly attached to an outer side wall of the shifting rod.

In another preferred embodiment, an upper surface of the soft rubber pad is provided with protruding portions, and the protruding portions surround a peripheral side of the through hole. A lower surface of the soft rubber pad is provided with an annular groove, and the annular groove surrounds the peripheral side of the through hole.

In another preferred embodiment, the soft rubber pad is made of silica gel or rubber.

In another preferred embodiment, the second end of the shifting rod is provided with a holding portion.

In another preferred embodiment, the shifting rod is movable relative to the fixing member between a first position and a second position, and the fixing member is provided with a first identifier corresponding to the first position and a second identifier corresponding to the second position.

Compared with the prior art, the present invention has the following advantages: the control switch having a protection function comprises the switch assembly; the switch assembly further comprises the shifting rod and the fixing member for mounting the shifting rod, and the fixing member is provided with the notch for mounting the shifting rod; the first end of the shifting rod extends into the fixing member and is hinged to the fixing member, and the second end of the shifting rod extends out from the fixing member; the soft rubber pad is arranged on an outer peripheral side of the shifting rod in a sleeving mode, and the soft rubber pad covers the notch; when the shifting rod is propelled, the soft rubber pad is propelled by the shifting rod to deform, so that the soft rubber pad always covers the gap formed between the notch and the shifting rod; when the shifting rod is propelled, it propels the soft rubber pad to deform, thereby allowing the soft rubber pad to always cover the gap formed between the notch and the shifting rod; in this way, the hair is prevented from entering the interior of the switch assembly from the gap between the notch and the shifting rod, so that the operating reliability of the switch assembly is significantly improved.

### BRIEF DESCRIPTION OF THE DRAWINGS

To more clearly illustrate specific embodiments of the present invention, the drawings required in the description of the embodiments are briefly described below. Obviously, the drawings in the following description are some embodiments of the present invention, and for those skilled in the art, other drawings may be obtained according to these drawings without paying creative labor.

FIG. 1 is a schematic diagram illustrating an overall structure of the switch assembly in the prior art;

FIG. 2 is a schematic diagram illustrating an interactive connection between the switch assembly and the housing of the present invention;

FIG. 3 is a schematic diagram illustrating an enlarged structure of portion A in FIG. 2;

FIG. 4 is a schematic diagram illustrating an overall structure of the switch assembly of the present invention;

FIG. 5 is a schematic diagram illustrating a sectional view of the switch assembly of the present invention;

FIG. 6 is another schematic diagram illustrating a sectional view of the switch assembly of the present invention;

FIG. 7 is another schematic diagram illustrating an explosive view of the switch assembly of the present invention;

FIG. 8 is a schematic diagram illustrating a perspective view of the soft rubber pad of the present invention;

FIG. 9 is another schematic diagram illustrating a perspective view of the soft rubber pad of the present invention;

FIG. 10 is a schematic diagram illustrating an exemplary structure of the fixing member of the present invention;

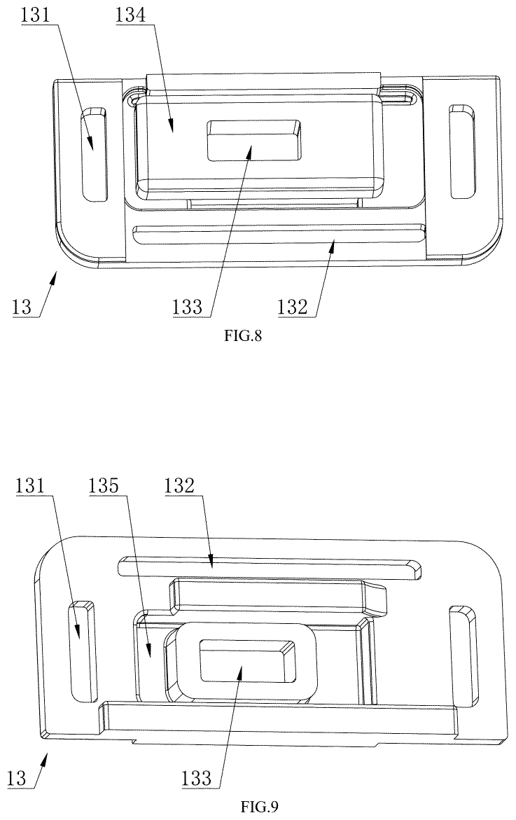

In FIGS. 1-10: 1-Switch Assembly, 11-Shifting Rod, 111-Holding Portion, 12-Fixing Member, 121-Notch, 122-Clamping Portion, 1221-Bending Portion, 123-T-shaped Block, 124-The First Identifier, 125-The Second Identifier, 13-Soft Rubber Pad, 131-Clamping Port, 132-Strip-shaped Notch, 133-Through Hole, 134-Protruding Portion, 135-Annular Groove, 2-Housing, 1′-Switch Assembly, 11′-Shifting Rod, 12′-Fixing Member.

### DETAILED DESCRIPTION

While specific embodiments of the invention have been described in detail, it will be appreciated by those skilled in the art that various modifications and alternatives to those details could be developed in light of the overall teachings of the present invention. Accordingly, the particular arrangements disclosed are meant to be illustrative only and not limiting as to the scope of the invention which is to be given the full breadth of the claims appended and any and all equivalents thereof.

In the description of the present invention, it should be understood that the orientations or positions indicated by the terms “central”, “transverse”, “longitudinal”, “perpendicular”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” are based on the orientations or positions shown in the figures, or the orientations or positions that the product of the present invention is commonly placed during use, or the orientations or positions that are commonly understood by those skilled in the art. They are merely for the convenience of describing and simplifying the description of the present invention, but not indicating or implying that the equipment or element referred to must have a specific orientation, or be constructed and operated in a specific orientation. Thus, they cannot be understood as a limitation of the present invention.

In addition, the terms “first” and “second” are used for descriptive purposes only and cannot be understood as the indication or implication of relative importance or the implication of the number of indicated technical features. Thus, a technical feature defined as “first” or “second” may explicitly or implicitly comprises one or more technical features. In the description of the present invention, unless it is clearly stated, “a plurality of” means two or more.

In the description of the present invention, unless it is clearly stated, the terms “installed”, “jointed”, “connected” and “fixed” shall be understood in a broad sense. For instance, it may be a fixed connection, a detachable connection, a mechanical connection, an electrical connection, a direct connection, an indirect connection through an intermediate medium, an internal connection of two components or an interaction between two components. For those skilled in the art, the specific meanings of the above terms in the present invention may be understood according to specific circumstances.

In the description of the present invention, unless it is clearly stated, the first feature being “above” or “below” the second feature may indicate that the first feature and the second feature are in direct contact or in indirect contact through other features between them. Moreover, the first feature being “on” or “above” the second feature may indicate that the first feature is directly above and obliquely above the second feature, or may simply indicate that the horizontal height of the first feature is higher than that of the second feature. The first feature being “below” the second feature may indicate that the first feature is directly below and obliquely below the second feature, or may simply indicate that the horizontal height of the first feature is lower than that of the second feature.

It should be noted that if an element is referred to as being “fixed to” or “arranged on” another element, it may be directly on another element or an intervening element exists. If an element is considered to be “connected” to another element, it may be directly connected to another element or an intervening element simultaneously exists. If there is an intervening element, the terms “vertical”, “horizontal”, “upper”, “lower”, “left” and “right” used in the present invention are for illustrative purposes only, which do not indicate that the present invention has only one embodiment.

It should be noted that the embodiments and features in the embodiments of the present invention may be combined with each other without conflict. Drawings and detailed embodiments are combined hereinafter to further elaborate the technical solution of the present invention.

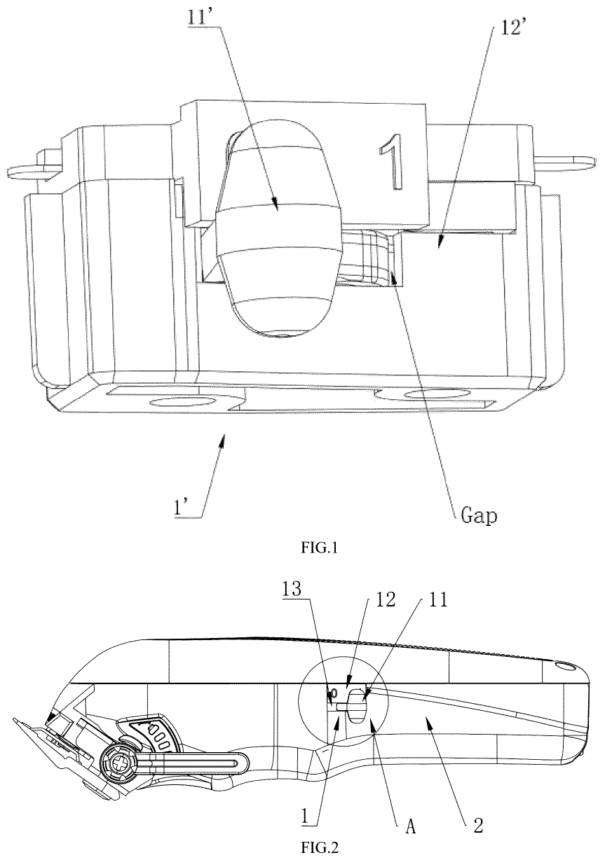

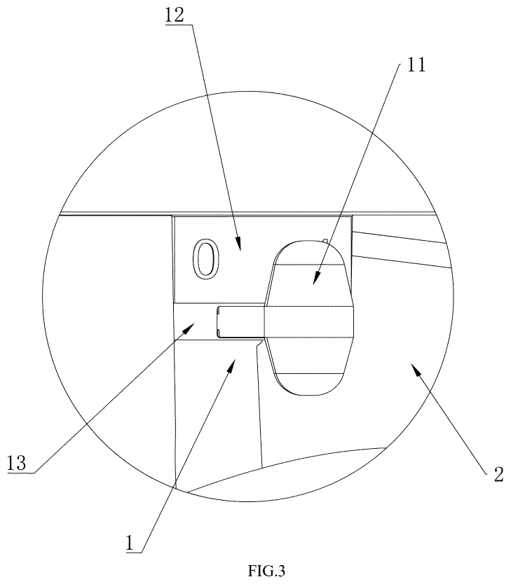

As shown in FIGS. 2-10, the control switch having a protection function comprises a switch assembly 1. The switch assembly 1 further comprises a shifting rod 11 and a fixing member 12 for mounting the shifting rod 11, and the fixing member 12 is provided with a notch 121 for mounting the shifting rod 11. A first end of the shifting rod 11 extends into the fixing member 12 and is hinged to the fixing member 12, and a second end of the shifting rod 11 extends out from the fixing member 12. A soft rubber pad 13 is arranged on an outer peripheral side of the shifting rod 11 in a sleeving mode, and the soft rubber pad 13 covers the notch 121. When the shifting rod 11 is propelled, the soft rubber pad 13 is propelled by the shifting rod 11 to deform, so that the soft rubber pad 13 always covers a gap formed between the notch 121 and the shifting rod 11.

Based on the above embodiment, the present invention provides the control switch having a protection function, comprising a switch assembly 1, wherein the switch assembly 1 comprises the shifting rod 11 and the fixing member 12 for mounting the shifting rod 11, and the fixing member 12 is provided with the notch 121 for mounting the shifting rod 11. The first end of the shifting rod 11 extends into the fixing member 12 and is hinged to the fixing member 12, and the second end of the shifting rod 11 extends out from the fixing member 12. The soft rubber pad 13 is arranged on the outer peripheral side of the shifting rod 11 in a sleeving mode, and the soft rubber pad 13 covers the notch 121. When the shifting rod 11 is propelled, it propels the soft rubber pad 13 to deform, so that the soft rubber pad 13 always covers the gap formed between the notch 121 and the shifting rod 11. The notch 121 of the fixing member 12 is provided with the soft rubber pad 13 for covering the gap formed between the notch 121 and the shifting rod 11. When the shifting rod 11 is propelled, it propels the soft rubber pad 13 to deform, thereby allowing the soft rubber pad to always cover the gap formed between the notch 121 and the shifting rod 11. In this way, the hair is prevented from entering the interior of the switch assembly 1 from the gap between the notch 121 and the shifting rod 11, so that the operating reliability of the switch assembly 1 is significantly improved.

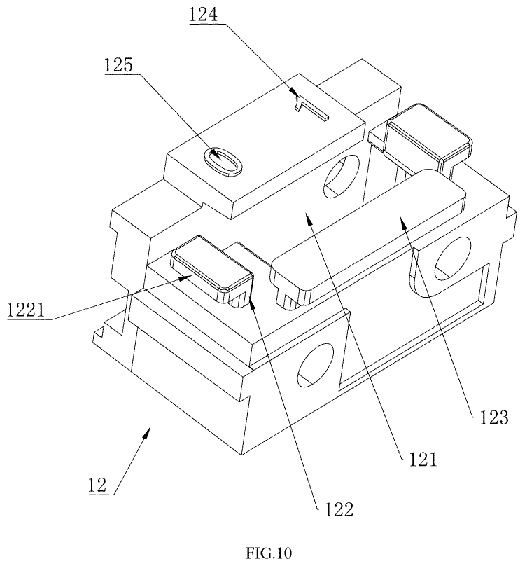

In another preferred embodiment, the periphery of the soft rubber pad 13 is fixedly connected to the fixing member 12. The fixing member 12 is provided with a clamping portion 122 for fixing two ends of the soft rubber pad 13, and both ends of the soft rubber pad 13 are respectively provided with a clamping port 131 for interacting with the clamping portion 122. The fixing member 12 is provided with a T-shaped clamping block 123 for fixing a side edge of the soft rubber pad 13, and the side edge of the soft rubber pad 13 is provided with a strip-shaped notch 132 engaged with the T-shaped clamping block 123. In this embodiment, as shown in FIGS. 9-10, when the soft rubber pad 13 is installed, the clamping portion 122 is clamped in the clamping port to fix the two ends of the soft rubber pad 13. In another preferred embodiment, an upper end of the clamping portion 122 is provided with a bending portion 1221 bent outward, and the bending portion 1221 prevents the soft rubber pad 13 from being disengaged from the clamping portion 122. In this embodiment, as shown in FIGS. 8 and 10, when the soft rubber pad 13 is installed, the strip-shaped notch 132 is arranged on the T-shaped clamping block 123 in a sleeving mode for fixing the side edge of the soft rubber pad 13.

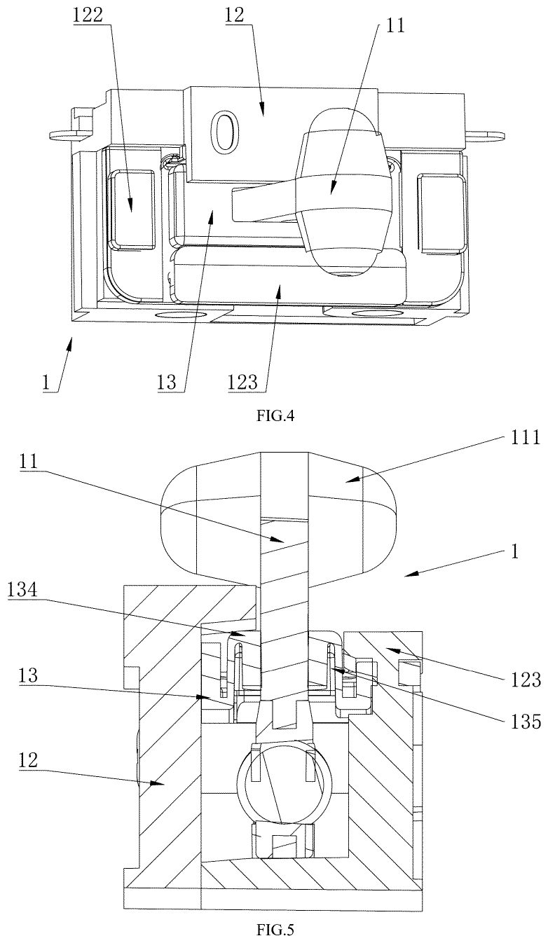

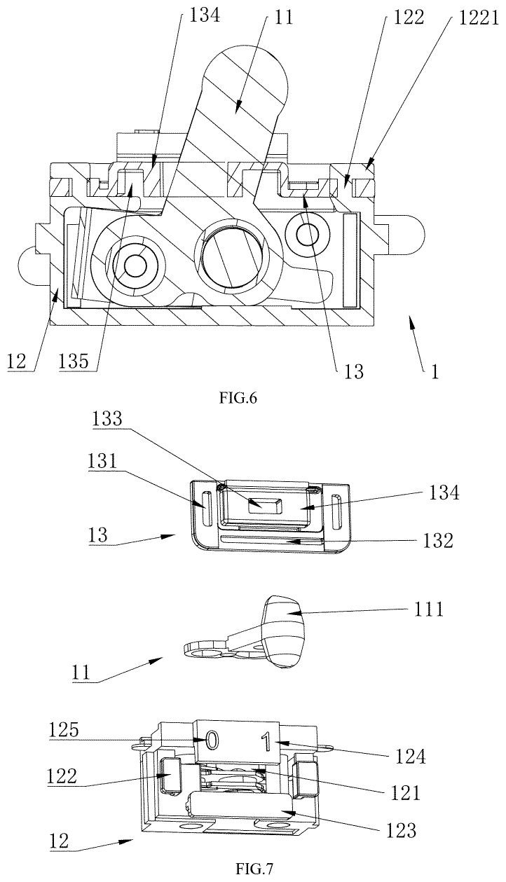

In another preferred embodiment, the soft rubber pad 13 is provided with a through hole 133 for interacting with the shifting rod 11, and an inner side wall of the through hole 133 is tightly attached to an outer side wall of the shifting rod 11. In this embodiment, as shown in FIGS. 4 and 6, the structural design enables the through hole 133 of the shifting rod 11 and the soft rubber pad 13 to closely interact as much as possible, thereby preventing the hair from entering the interior of the switch assembly 1 from the gap between the notch 121 and the shifting rod 11.

In another preferred embodiment, an upper surface of the soft rubber pad 13 is provided with a protruding portion 134, and the protruding portion 134 surrounds a peripheral side of the through hole 133. A lower surface of the soft rubber pad 13 is provided with an annular groove 135, and the annular groove 135 surrounds the peripheral side of the through hole 133. In this embodiment, as shown in FIGS. 8-9, the protruding portion 134 effectively increases the contact area between the through hole 133 and the shifting rod 11, which helps reducing the gap between the the notch 121 and the shifting rod 11. The arrangement of the annular groove 135 facilitates the deformation of the soft rubber pad 13, allowing the soft rubber pad 13 to deform along with the positional change of the shifting rod 11. Thus, the soft rubber pad 13 always covers the gap between the shifting rod 11 and the notch 121 of the fixing member 12.

In another preferred embodiment, the soft rubber pad 13 is made of silica gel or rubber. In this embodiment, the silica gel or the rubber material has good flexibility and elasticity. The soft rubber pad 13 made of silica gel or rubber is capable of deforming along with the positional change of the shifting rod 11. Definitely, in another preferred embodiment, the soft rubber pad 13 may also be made of other flexible materials having the same function.

In another preferred embodiment, the second end of the shifting rod 11 is provided with a holding portion 111. In this embodiment, as shown in FIG. 3, the holding portion 111 is provided at the second end of the shifting rod 11 extending out from the fixing member 12, and the holding portion 111 is exposed outside a housing 2 of the electric hair cutter, which allows the electric hair cutter to be conveniently used.

In another preferred embodiment, the shifting rod 11 is movable relative to the fixing member 12 between a first position and a second position, and the fixing member 12 is provided with a first identifier 124 corresponding to the first position and a second identifier 125 corresponding to the second position. In this embodiment, as shown in FIG. 10, the first position is a power-on position, and the second position is a power-off position. Correspondingly, the first identifier 124 is a “1” identifier, and the second identifier 125 is a “0” identifier. This arrangement allows a user to conveniently and quickly confirm the on/off state of the electric hair cutter.

Obviously, the above embodiments are merely examples for clear description and are not intended to limit the implementations of the present invention. For those skilled in the art, modifications or variations may be made on the basis of the above description. It is unnecessary and impossible to exhaustively list all implementations herein. The obvious modifications or variations made based on the above description shall fall into the scope defined by the claims of the present invention.

What is claimed is:

1. A control switch having a protection function, comprising:
a switch assembly (1), wherein the switch assembly (1) comprises:
a shifting rod (11) and a fixing member (12) for mounting the shifting rod (11), wherein the fixing member (12) is provided with a notch (121) for mounting the shifting rod (11), wherein a first end of the shifting rod (11) extends into the fixing member (12) and is hinged to the fixing member (12), wherein a second end of the shifting rod (11) extends out from the fixing member (12), wherein a soft rubber pad (13) is arranged on an outer peripheral side of the shifting rod (11) in a sleeving mode, wherein the soft rubber pad (13) covers the notch (121), and wherein when the shifting rod (11) is propelled, the soft rubber pad (13) is propelled by the shifting rod (11) to deform, so that the soft rubber pad (13) always covers a gap formed between the notch (121) and the shifting rod (11).

2. The control switch having a protection function of claim 1, wherein the periphery of the soft rubber pad (13) is fixedly connected to the fixing member (12).

3. The control switch having a protection function of claim 2, wherein the fixing member (12) is provided with a clamping portion (122) for fixing two ends of the soft rubber pad (13), and wherein the two ends of the soft rubber pad (13) are respectively provided with a clamping port (131) for interacting with the clamping portion (122).

4. The control switch having a protection function of claim 2, wherein the fixing member (12) is provided with a T-shaped clamping block (123) for fixing a side edge of the soft rubber pad (13), and wherein the side edge of the soft rubber pad (13) is provided with a strip-shaped notch (132) engaged with the T-shaped clamping block (123).

5. The control switch having a protection function of claim 3, wherein the fixing member (12) is provided with a T-shaped clamping block (123) for fixing a side edge of the soft rubber pad (13), and wherein the side edge of the soft rubber pad (13) is provided with a strip-shaped notch (132) engaged with the T-shaped clamping block (123).

6. The control switch having a protection function of claim 1, wherein the soft rubber pad (13) is provided with a through hole (133) for interacting with the shifting rod (11), and wherein an inner side wall of the through hole (133) is tightly attached to an outer side wall of the shifting rod (11).

7. The control switch having a protection function of claim 5, wherein an upper surface of the soft rubber pad (13) is provided with protruding portions (134), wherein the protruding portions (134) surround a peripheral side of the through hole (133), wherein a lower surface of the soft rubber pad (13) is provided with an annular groove (135), and wherein the annular groove (135) surrounds the peripheral side of the through hole (133).

8. The control switch having a protection function of claim 1, wherein the soft rubber pad (13) is made of silica gel or rubber.

9. The control switch having a protection function of claim 1, wherein the second end of the shifting rod (11) is provided with a holding portion (111).

10. The control switch having a protection function of claim 1, wherein the shifting rod (11) is movable relative to the fixing member (12) between a first position and a second position, and wherein the fixing member (12) is provided with a first identifier (124) corresponding to the first position and a second identifier (125) corresponding to the second position.
